(19) United States
(12) Patent Application Publication
(10) Pub. No.: US 2026/0205188 A1
(43) Pub. Date: Jul. 16, 2026

(54) BEAM MANAGEMENT IN A RECONFIGURABLE VIRTUAL USER EQUIPMENT

(71) Applicant: Telefonaktiebolaget LM Ericsson (publ), Stockholm (SE)

(72) Inventors: Andreas NILSSON, Göteborg (SE); Magnus NILSSON, Kungsbacka (SE); Mikael COLDREY, Borås (SE); Sam AGNEESSENS, Torslanda (SE); Sven JACOBSSON, Västra Frölunda (SE)

(73) Assignee: Telefonaktiebolaget LM Ericsson (publ), Stockholm (SE)

(21) Appl. No.: 19/134,807

(22) PCT Filed: Dec. 8, 2022
(86) PCT No.: PCT/EP2022/084930

§ 371 Date: Jun. 2, 2025

(51) Int. Cl. H04B 7/06; H04W 24/10

(52) U.S. Cl. CPC H04B 7/06952; H04W 24/10

(57) ABSTRACT

A user equipment (120), which has been configured by a network (110) to operate as coordinator UE in a reconfigurable virtual user equipment, RVUE, which further includes at least one non-coordinator UE. The coordinator UE is configured to: indicate to the network a capability of RVUE-coordinated beam management; receive from the network a configuration of a RVUE-coordinated beam management procedure, in which a beam-reporting task is delegated from the non-coordinator UEs to the coordinator UE; and perform measurements and reporting in accordance with the configuration of the RVUE-coordinated beam management procedure. In some embodiments, the coordinator UE is configured to transmit a beam report (310) with a mandatory report part (311) and an optional report part (312), where the mandatory report part indicates a beam preferred by the coordinator UE (e.g., on the basis of its own measurements), and the optional report part indicates a beam preferred by a non-coordinator UE.

### TECHNICAL FIELD

The present disclosure relates to the field of cellular communication between multiantenna transceivers. In particular, it proposes a technique for determining a beam suitable for communication between a network node and a reconfigurable virtual user equipment (RVUE).

### BACKGROUND

Narrow beam transmission and reception schemes will be needed at higher frequencies to compensate the high propagation loss. It is expected that a transmit (TX) beam which is suitable for use by a base station 110 (FIG. 1) for each user equipment (UE) 120 will be discovered and monitored by the network using measurements on downlink reference signals used for beam management, such as Channel State Information Reference Signal (CSI-RS) or Synchronization Signal Block (SSB). CSI-RS and SSB have been agreed in 3GPP to be used as beam reference signal for the fifth-generation technology New Radio (NR). The CSI-RS for beam management can be transmitted periodically, semi-persistently or aperiodically, and they can either be shared between multiple UEs or be UE-specific. The SSB are transmitted periodically and are shared for all UEs. In order to find a suitable gNB beam (base-station beam), the gNB transmits CSI-RS/SSB in different gNB TX beams on which the UE performs RSRP measurements and reports back the N best gNB TX beams and their corresponding RSRP value, where N is a number which can be configured by the network.

Although not explicitly stated in the NR specification, beam management has been divided into three procedures, schematically illustrated in FIG. 2:
P-1: Purpose is to find an approximate direction for the UE 120 using wide gNB Tx beams 211, 212, 213 from the gNB 110 covering the whole angular sector. The UE 120 can use a single Rx beam 221.
P-2: Purpose is to refine the gNB Tx beam by doing a new beam search around the coarse direction found in P-1, namely, by transmitting regular (narrow) Tx beams 214, 215, 216. The UE 120 can use a single Rx beam 222.
P-3: Used for UEs that have analog beamforming to let them find a suitable UE Rx beam. In P-3, the UE 120 receives on multiple beams 223, 224, 225 while the gNB 110 transmits on a constant beam 217, which is preferably a regular (narrow) beam.

P-1 is expected to utilize beams with rather large beamwidths and where the beam reference signals are transmitted periodically and are shared between all UEs of the cell. Typically reference signal to use for P-1 are periodic CSI-RS or SSB. The UE then reports the N best beams to the gNB and their corresponding RSRP values. P-2 is expected to use aperiodic/or semi-persistent CSI-RS transmitted in narrow beams 214, 215, 216 around the coarse direction found in P-1. P-3 is expected to use aperiodic or semi-persistent CSI-RSs repeatedly transmitted in one narrow gNB beam 217. One alternative way is to let the UE determine a suitable UE Rx beam based on the periodic SSB transmission. Since each SSB consists of four OFDM symbols, a maximum of four UE Rx beams 223, 224, 225 can be evaluated during each SSB burst transmission. One benefit with using SSB instead of CSI-RS is that no extra overhead of CSI-RS transmission is needed.

To illustrate possible relations between wider and narrower beams, a collection of four wide beams WB1-WB4 and thirty-two narrow beams NB1-NB32 is considered. The beams are assumed to be spatially oriented in such manner that WB1 is the best approximation of NB1-NB8, that WB2 is the best approximation of NB9-NB16, that WB3 is the best approximation of NB17-NB24 and WB4 is the best approximation of NB25-NB32. The wide beams could be used in a first periodic gNB TX beam management procedure (P-1) to find a coarse direction of the UE, and the narrow beams can be used in a second gNB TX beam management procedure (P-2) in order to find a narrow gNB TX beam to be used for data transmission. The typical way to select beams for the P-2 procedure is to determine which one of the wide beams was the optimal one with respect to Reference Signals Received Power (RSRP) and then to select the narrow beams that are confined within the angular coverage area of that wide beam. Assuming, for example, that the wide beam WB1 was the best wide beam, then the beams for the P-2 procedure would be the narrow beams NB1-NB8.

Cellular technology generally evolves towards operation at gradually higher frequency. Because directivity tends to increase with frequency, a very large number of narrow beams are available for transmissions between base stations and a wireless device in the millimeter-wave range. As a result, the complexity of the necessary beam management procedures grows and overhead related to beam measurements is becoming an increasingly severe concern. More efficient beam management procedures will therefore be a valuable asset in the further evolution of 3GPP NR (‘5G’) and future 6G technology. The complexity and overhead problems may as well be addressed by proprietary solutions.

### SUMMARY

One objective of the present disclosure is to make available a beam management method with a reduced overhead per wireless device. It is desirable to reduce the quantity of time and/or radio resources devoted to beam management and beam reporting, notably the quantity per wireless device in operation. A further objective is to make available a beam management method with a reduced complexity. A further objective is to make available a beam management method which scales advantageously with the number of wireless devices in the coverage area of a network node, e.g., the active devices in a cell. Still further objectives include the providing of wireless devices and networks nodes adapted for the novel beam management method.

At least some of these objectives are achieved by the invention as defined by the independent claims. The dependent claims relate to advantageous embodiments of the invention.

In a first aspect of the present disclosure, there is provided a user equipment (UE), which a network has configured to operate as coordinator UE in a reconfigurable virtual user equipment (RVUE). It is understood that the RVUE further includes at least one non-coordinator UE and optionally one or more additional transceiver devices. The coordinator UE comprises a radio interface and processing circuitry, and it is configured to: indicate to the network a capability of RVUE-coordinated beam management; receive from the network a configuration of a RVUE-coordinated beam management procedure, in which a beam-reporting task is delegated from the non-coordinator UEs to the coordinator UE; and perform measurements and reporting in accordance with the configuration of the RVUE-coordinated beam management procedure.

In a second aspect, there is provided a method in a (coordinator) UE, comprising: receiving a configuration from a network for the UE to operate as coordinator UE in a RVUE, which further includes at least one non-coordinator UE; indicating to the network a capability of RVUE-coordinated beam management; receiving from the network a configuration of a RVUE-coordinated beam management procedure, in which a beam-reporting task is delegated from the non-coordinator UEs to the coordinator UE; and performing (1408) measurements and reporting in accordance with the configuration of the RVUE-coordinated beam management procedure.

In a third aspect, there is provided a UE, which a network has configured to operate as non-coordinator UE in a RVUE. It is understood that the RVUE further includes a coordinator UE and optionally one or more additional transceiver devices. The non-coordinator UE comprises a radio interface and processing circuitry, and it is configured to: receive from the coordinator UE an indication that a RVUE-coordinated beam management procedure shall be performed, in which a beam-reporting task is delegated from the non-coordinator UEs to the coordinator UE; perform measurements in accordance with the RVUE-coordinated beam management procedure; and transmit beam-related information to the coordinator UE.

In a fourth aspect, there is provided a method in a (non-coordinator) UE, comprising: receiving a configuration from a network for the UE to operate as non-coordinator UE in a RVUE, which further includes one coordinator UE and optionally at least one further non-coordinator UE; receiving from the coordinator UE an indication that a RVUE-coordinated beam management procedure shall be performed, in which a beam-reporting task is delegated from the non-coordinator UEs to the coordinator UE; performing measurements in accordance with the RVUE-coordinated beam management procedure; and transmitting beam-related information to the coordinator UE.

In a fifth aspect, there is provided a network node (e.g., base station, such as a gNB) comprising a radio interface and processing circuitry. The network node is configured to: configure a UE to operate as coordinator UE in a (new or existing) RVUE; configure one or more further UEs to operate as non-coordinator UEs in the same RVUE; receive from the coordinator UE an indication of a capability of RVUE-coordinated beam management; transmit to the coordinator UE a configuration of a RVUE-coordinated beam management procedure, in which a beam-reporting task is delegated from the non-coordinator UEs to the coordinator UE; and receive reporting from the coordinator UE in accordance with the configuration of the RVUE-coordinated beam management procedure.

In a sixth aspect, there is provided method in a network node, comprising: configuring a UE to operate as coordinator UE in a RVUE; configuring one or more further UEs to operate as non-coordinator UEs in the same RVUE; receiving from the coordinator UE an indication of a capability of RVUE-coordinated beam management; transmitting to the coordinator UE a configuration of a RVUE-coordinated beam management procedure, in which a beam-reporting task is delegated from the non-coordinator UEs to the coordinator UE; and receiving reporting from the coordinator UE in accordance with the configuration of the RVUE-coordinated beam management procedure.

In a seventh aspect, finally, the present disclosure provides a computer program containing instructions for causing a computer—or processing circuitry within the UE or network node in particular—to carry out one of the above methods. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

Each of the first, second, third, fourth, fifth, sixth and seventh aspects enable a coordination of beam management on the level of each RVUE. For example, a beam-reporting task can be delegated from a non-coordinator UE within the RVUE to a coordinator UE within the same RVUE. This way, the non-coordinator UEs within the RVUE can refrain from sending their own beam reports to the network. In comparison with a setup where each UE is responsible for its own beam reporting—normally this is the condition that applies before the network configures RVUEs—the reduction in overhead can be substantial. In a scenario where half of the UEs in a cell are successfully grouped into RVUEs with three devices in each, up to a third of the UEs are theoretically able to refrain from performing their own beam reporting, which avoids a great deal of reporting overhead. Additionally, the coordination on RVUE level can contributed to relieving a subset of the UEs from the requirement to make their own beam measurements and/or to receive their own beam control messages from the network. The UEs in this subset can instead rely on beam measurements performed by other UEs and/or on beam control messages that said other UEs exchange with the network.

In a first group of embodiments, the coordinator UE is configured to transmit, within the RVUE-coordinated beam management procedure, a beam report with a mandatory report part and an optional report part to the network. The mandatory report part indicates at least one base-station beam preferred by the coordinator UE (e.g., on the basis of measurements performed or processed by the coordinator UE), and the optional report part indicates at least one base-station beam preferred by a non-coordinator UE (e.g., on the basis of measurements performed or processed by the non-coordinator UE) in the RVUE. An effect of the technical features of the first group of embodiments, notably the two-part structure of the beam report, may be that the average size of the transmitted beam reports decreases, so that a relatively smaller share of the network's transmission resources is spent on beam reporting.

In this connection, it is noted that a “base-station beam” may be defined by a downlink reference signal resource (DL RS). More precisely, the UE may be required to perform measurements on a set of DL RS resources, wherein each DL RS resource is transmitted in a separate base station beam. Then, the beam report could include indexes to the UE's preferred DL RS(s), or its preferred DL RS resource(s), which are in a one-to-one relationship with the corresponding beams. Specifically, the DL-RS index may be used to indicate a (beam) spatial filter that the DL-RS was transmitted in.

In a second group of embodiments, the coordinator UE is further configured to select, within the RVUE-coordinated beam management procedure, at least one collectively preferred base-station beam based on a joint performance metric evaluated for coordinator and non-coordinator UEs in the RVUE, and to transmit a beam report indicating said collectively preferred base-station beam. Optionally the preferred base-station beam is based on the joint performance metric evaluated for all coordinator and non-coordinator UEs in the RVUE. This group of embodiments enables the use of a joint performance metric, to be exemplified below, which may be different from the metric or criterion that an individual UE applies in order to determine a preferred base-station beam.

In a third group of embodiments, where said collectively preferred base-station beam is a relatively wider beam (e.g., SSB beam, periodic CSI-RS), the RVUE-coordinated beam management procedure further includes a step where the coordinator and non-coordinator UEs in the RVUE report their respective preferred base-station beams selected from a set of relatively narrower beams (e.g., aperiodic or semi-persistent CSI-RS) to the network. As it may be expected that the UEs in the RVUE are more likely to agree about the preferred broad beam, the RVUE-coordinated beam management according to the embodiments in this third group strikes an advantageous balance between the collective and the individual beam management approach.

Two or more technical features can generally be combined, even if they are disclosed herein in the context of the different groups of embodiments, or in the context of different embodiments within these groups.

In still further embodiments, combinable with each of the three groups, the coordinator UE is further configured to indicate to the network a spatial separation of the coordinator UE, the non-coordinator UEs and/or any additional transceiver devices in the RVUE. The spatial separation may be expressed as a linear physical distance, a degree of divergence of the respective spatial orientations (e.g., difference emission angles of main lobes) or a combination of these. The indicated spatial separation provides the network with a reliable basis for deciding whether or not to configure these UEs (and additional transceiver devices) to operate as a RVUE. In general terms, more efficiency gains can be expected if the spatial separation is small, since the UEs within the RVUE are more likely to prefer the similar base-station beams. This fact reduces the likelihood of having to report exceptions from the collectively preferred beam to the network. It further suggests that good radio performance can be substantially maintained even if some UEs have to transmit on a lower-ranking beam rather than their individual preference.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method described herein do not have to be performed in the exact order disclosed, unless explicitly stated.

### BRIEF DESCRIPTION OF THE DRAWINGS

Aspects and embodiments are now described, by way of example, with reference to the accompanying drawings, on which:

FIG. 1 shows a wireless device in the coverage area of one single-TRP base station and one multi-TRP base station;

FIG. 2 illustrates three example beam management procedures;

FIG. 3 illustrates a beam management procedure between a base station and a RVUE;

FIG. 4 shows a RVUE;

FIG. 5 shows a set of wireless devices under the common control of a human user which are configured for independent beam management;

FIG. 6 shows the wireless devices in FIG. 5 while performing RVUE-coordinated beam management;

FIG. 7 shows a set of wireless devices under the common control of a human user, wherein at least one device has multiple transmit/receive chains;

FIG. 8 shows the wireless devices in FIG. 7 while performing RVUE-coordinated beam management;

FIGS. 9 and 10 illustrate an example situations where two devices within a RVUE can assist each other to cope with the temporary presence of a blocking object;

FIG. 11 shows an example situation where a first device in a RVUE is blocked by the user's body and needs a separate beam-pair link than a second device in the same RVUE, which has a free line of sight to a transmission point;

FIG. 12 illustrates the assignment of base-station beams to different wireless devices in an example situation;

FIG. 13 illustrates an example situation where a RVUE's collectively preferred base-station beam is relatively wider and the devices within the RVUE have the option of selecting relatively narrower preferred beams; and

FIGS. 14, 15 and 16 are flowcharts of methods according to embodiments herein, to be implemented by a coordinator UE, a non-coordinator UE and a network node, respectively.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

### System Overview

In general terms, the present disclosure proposes solutions for overhead-efficient beam management procedures in multiples UEs which are configured to operate as a reconfigurable virtual UE (RVUE). For alternative characterizations of an RVUE and related technical information, reference is made to the applicant's parallel disclosures [applicant reference: P105673WO01] and [applicant reference: P106126WO01], which are hereby incorporated by reference.

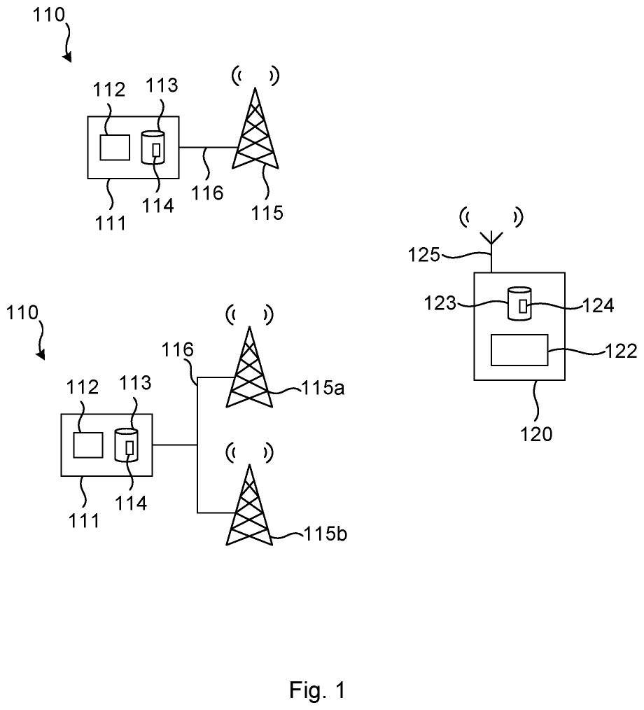

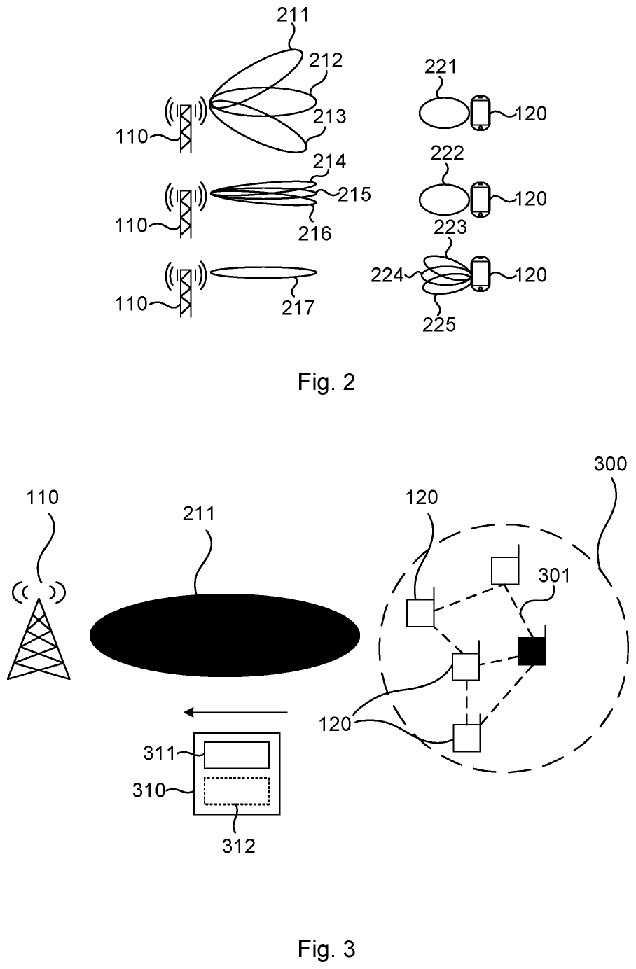

A possible technical context is illustrated in FIG. 1, which shows a wireless device 120 located in the coverage area of one network node 110 with a single transmission point (TRP) 115 (upper portion of FIG. 1), and one network node 110 with two TRPs 115a, 115b (lower portion of FIG. 1). The network nodes 110 are configured as base stations in a radio access network within a cellular telecommunication system, especially as gNBs in a 3GPP NR system. It is understood that the teachings disclosed herein can be readily generalized beyond the NR technology; rather, they are applicable with same or similar benefits to a telecommunication system that is consistent with 6G requirements and higher.

The figure schematically illustrates, in terms of a number of functional units, the components of the wireless device 120 according to an embodiment. Processing circuitry 122 is provided using any combination of one or more of a suitable central processing unit (CPU), multiprocessor, microcontroller, digital signal processor (DSP), etc., capable of executing software instructions stored in a computer program product 124, e.g. in the form of a storage medium 123. The processing circuitry 122 may further be provided as at least one application specific integrated circuit (ASIC), or field programmable gate array (FPGA). Particularly, the processing circuitry 122 is configured to cause the wireless device 120 to perform a set of operations, or steps, as disclosed below with reference to FIG. 14 or 15. For example, the storage medium 123 may store the set of operations, and the processing circuitry 122 may be configured to retrieve the set of operations from the storage medium 123 to cause the wireless device 120 to perform the set of operations. The set of operations may be provided as a set of executable instructions. The storage medium 123 may also comprise persistent storage, which, for example, can be any single one or combination of magnetic memory, optical memory, solid state memory or even remotely mounted memory.

The wireless device 120 may further comprise a communications interface 125 for communications with the network nodes 110. As such, the communications interface 125 may comprise one or more transmitters and receivers, comprising analog and digital components. The processing circuitry 122 controls the general operation of the wireless device 120, e.g. by sending data and control signals to the communications interface 125 and the storage medium 123, by receiving data and reports from the communications interface 125, and by retrieving data and instructions from the storage medium 123. Other components, as well as the related functionality, of the wireless device 120 are omitted in order not to obscure the concepts presented herein.

FIG. 1 further illustrates, in terms of a number of functional units, the components of the network nodes 110 according to an embodiment. The network nodes 110 may be base stations, such as gNBs in 3GPP NR. Each network node 110 comprises a frontend unit 111 and a TRP 115 joined by a connection line 116. The frontend unit 111 may be co-located with the TRP 115 or located remotely from this. In the frontend unit 111, processing circuitry 112 is provided using any combination of one or more of a suitable CPU, multiprocessor, microcontroller, DSP, etc., capable of executing software instructions stored in a computer program product 114, e.g. in the form of a storage medium 113. The processing circuitry 112 may further be provided as at least one ASIC or FPGA. Particularly, the processing circuitry 112 is configured to cause each network node 110 to perform a set of operations, or steps, as disclosed below with reference to FIG. 16. For example, the storage medium 113 may store the set of operations, and the processing circuitry 112 may be configured to retrieve the set of operations from the storage medium 113 to cause the wireless device 110 to perform the set of operations. The set of operations may be provided as a set of executable instructions. The storage medium 113 may also comprise persistent storage, as exemplified above.

The network node 110 may further comprise a communications interface including the TRP 115 for communications with the wireless device 120. As such, the communications interface may comprise one or more transmitters and receivers, comprising analogue and digital components. The processing circuitry 112 controls the general operation of the network node 110, e.g. by sending data and control signals to the communications interface (with the TRP 115) and the storage medium 113, by receiving data and reports from the communications interface, and by retrieving data and instructions from the storage medium 113. Other components, as well as the related functionality, of the network nodes 110 are omitted in order not to obscure the concepts presented herein.

It is noted that although some terms that are used in 3GPP Long Term Evolution (LTE) or 3GPP NR based systems, such as sounding reference signal (SRS), physical uplink shared channel (PUSCH) etc., the embodiments to be disclosed are not limited to these particular signals or concepts. Rather, these are to be construed as illustrative examples intended to provide a better understanding of the disclosed embodiments. For example, an SRS is an example of an uplink reference signal used to sound the uplink channel and/or the downlink channel. Such an uplink reference signal can, for example, be used to estimate the downlink channel for reciprocity-based downlink transmission or for codebook based uplink transmissions.

### Coordinated Beam Management

FIG. 3 illustrates how a plurality of wireless devices 120 can be configured as a reconfigurable virtual UE (RVUE) 300 by the network 110. The plurality of devices constituting the RVUE are able to communicate with each other without involving the network 110, e.g., via NR sidelink, Bluetooth, Wi-Fi™, or some other wired or wireless interface, indicated by 301 in FIG. 3. At least one of the wireless devices 120 is configured to act as coordinator UE (hatched in FIG. 3) and is thus responsible for informing the network 110 that such an intra-RVUE communication capability exists between a collection of wireless devices 120, whereby the network 110 can take an informed decision whether this collection of wireless devices 120 is to operate as a RVUE. The intra-RVUE communication capability may alternatively be described as an interface for non-cellular communication, or in particular a non-cellular signaling interface. As will be seen below, the total signaling overhead can be reduced if a percentage of the wireless devices 120 are grouped together as RVUEs.

In some embodiments, the network's 110 decision whether to configure a group of wireless devices 120 as a RVUE can be further supported by a spatial separation indicated by the coordinator UE. The spatial separation may be expressed as a linear physical distance, a degree of divergence of the respective spatial orientations (e.g., difference emission angles of main lobes) or a combination of these. Accordingly, the network 110 may apply a criterion for forming RVUEs that not only should the wireless devices 120 possess an intra-RVUE communication capability but their spatial separation should not exceed a threshold. More efficiency gains can be expected if the spatial separation is small, since the devices within the RVUE are more likely to prefer the similar base-station beams. As an alternative to an absolute threshold, the network 110 may apply a criterion, in addition to the intra-RVUE communication capability, that the value of the spatial separation should be one of the N smallest values in the cell, where N is a preconfigured number.

Examples of a RVUE include:
A set of so-called smart devices (e.g., watch, virtual-reality glasses, augmented-reality glasses, other wireless-enabled wearables) connected to a same phone/tablet. The phone/tablet together with the smart devices can be configured as a RVUE.
No phone/tablet is used, but the smart devices operate as a RVUE independently. Then, for example, the AR/VR glasses could be configured as coordinator UE within the RVUE. The coordinator UE might for example be responsible for controlling the connection between the different devices associated to the RVUE.
Communication equipment (e.g., phones, tablets, laptops) owned/managed by a same company and/or user.
Communication equipment (e.g., modem/router, computer) connected to a same local-area network.
Communication equipment (e.g., phones, tables, laptops) that located in a vehicle with communication capabilities (e.g., car, bus, train).

Large gains can be expected in the use case where mobile phones belonging to densely seated passengers in a public transport vehicle with metal walls are operated as one or more RVUEs.

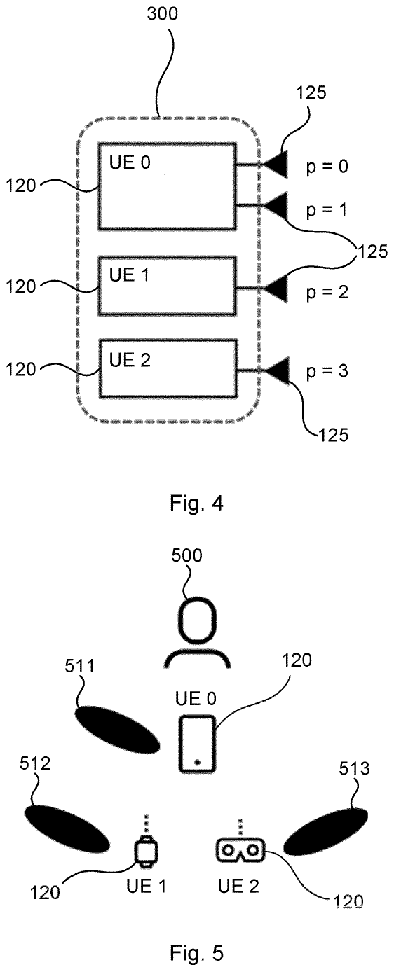

FIG. 4 shows a RVUE 300 formed by a first device 120 (UE0) with two antenna ports (p=0,1), which may be implemented as a single antenna panel or two antenna panels, as well as a second and a third device 120 (UE1, UE2) equipped with a single antenna port each (p=2, p=3). The RVUE 300 thus has four antenna ports at its disposal. In one use case, the first device is a mobile phone, the second device is a smart watch, and the third device is a pair of smart glasses. It may be suitable for the network 110 to configure the mobile phone as coordinator UE, namely, since it is likely to have a more sophisticated wireless interface 125 and better battery and more powerful processing resources. The second and third devices may or not be UEs from the perspective of the network. If they are UEs, the operate as non-coordinator UEs in the RVUE, which may imply that they delegate some interaction with the network (e.g., beam reporting) which is instead to be performed by the coordinator UE on the non-coordinator UE's behalf. If the second and third devices are not configured or expected to interact with the network 110, their membership in the RVUE may be as additional transceiver devices.

FIG. 5 shows three wireless devices 120 under the common control of a human user 500: a mobile phone UE0, a smart watch UE1 and a pair of smart glasses UE2. Here, each of the wireless devices 120 are configured for independent beam management. Additionally, the smart watch UE1 and smart glasses UE2 are connected to the mobile phone UE0 via some device-to-device (D2D) wireless technology, such as Bluetooth™ The D2D connection constitutes an intra-RVUE communication capability.

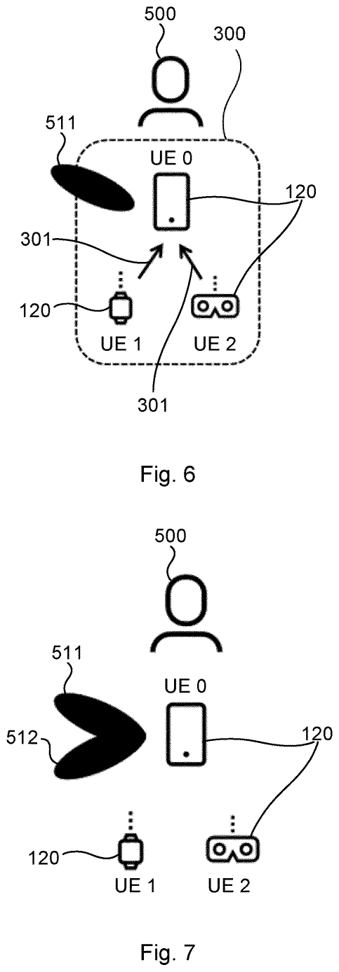

FIG. 6 shows the devices from FIG. 5 in a condition where they operate as a RVUE. This may be achieved in two stages.

First, the mobile phone UE0 indicates to the network 110 that the three devices are capable of operating as a RVUE, e.g., because they have an intra-RVUE communication capability. This capability to operate as a RVUE could be indicated during UE-capability signaling and could for example indicate the number of devices, the number of antenna ports per device, coherence capability per device, maximum output power per device, and so on. Optionally, the mobile phone UE0 may further indicate the spatial separation of the three devices, which in this example can be expected to be small as all three devices are carried on the user's 500 body or clothing.

Then, after the network 110 has received the indication that the three devices are capable of operating as a RVUE (and any additional information), it sends a configuration to the devices that they are to operate as a RVUE. (From a functional point of view, it is likely immaterial whether the devices are considered to be a RVUE before they receive the configuration, or whether they become a RVUE at this point in time.) The configuration can be sent as a common message to the intended coordinator UE (here, mobile phone UE0) or as separate messages to those of the devices UE0, UE1, UE2 that have a capability to communicate with the network 110. If not all devices in the new RVUE receive the message(s) with the configuration, its content will have to be forwarded within the RVUE. The coordinator UE and any additional non-coordinator UEs and/or additional transceiver devices may then communicate with the network in accordance with the RVUE configuration.

FIG. 6 illustrates the RVUE 300 at a point in time where totality of the devices' 120 communication with the network 110 is performed by the coordinator UE 120. A non-coordinator UE may hand over its data to be exchanged with the network 110 (in suitably encapsulated form) to the coordinator UE, which forwards it accordingly. Conversely, the coordinator UE may receive data on a non-coordinator UE's behalf and forward the data after receipt. This concentration of the communications may be a result of the prevailing configuration of the RVUE. In particular, the configuration could stipulate that the communications shall be concentrated (i.e., be performed via the coordinator UE) when the total data flow is below a threshold, whereas the non-coordinator UEs may communicate directly with the network 110 when the total data flow is higher than the threshold. This increases the throughput, notably thanks to the higher utilization of spatial diversity.

FIG. 7 shows the same three wireless devices 120 as in FIG. 5, with an intra-RVUE communication capability. A difference is that the mobile phone UE0 has dual transmit/receive chains enabling it to transmit/receive on two beams 511, 512 contemporaneously.

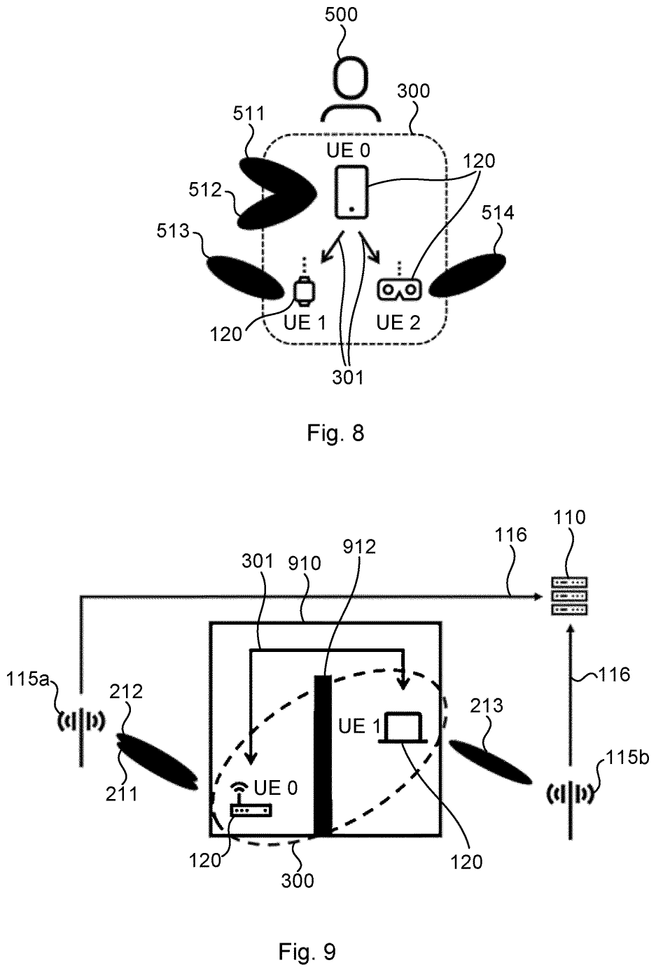

FIG. 8 shows an RVUE 300 formed from the wireless devices 120 in FIG. 7 in a condition where all three devices 120 are active transmitting or receiving on respective beams 511, 512, 513, 514. It is seen that the beams 511, 512 in use by the mobile phone UE0 and the beam 513 used by the smart watch UE1 share an approximate direction. It may be expected that both the mobile phone UE0 and the smart watch UE1 can reach adequate performance (e.g., in terms of data throughput) for the same beam direction, indeed, since the devices are separated by a rather small physical distance and neither is obstructed by the user's 500 body.

FIG. 9 shows a further example, where a wireless device 120 in the form of a cellular modem/router UE0 and a further wireless device 120 in the form of a laptop computer UE1 have been configured by a network to operate as a RVUE 300. The laptop computer, possibly along with several other devices that do not have any cellular-communication capabilities, connects to the local area network (LAN) provided by the cellular modem/router UE0. UE0 and UE1 are thereby inter-connected via a non-cellular interface 301 (e.g., Wi-Fi™ or Ethernet) constituting an intra-RVUE communication capability. Furthermore, as shown in FIG. 9, the cellular modem/router UE0 and laptop computer UE1 are situated on different sides of a blocking wall 912 in a room 910, their respective preferred connections are to different transmission points 115a, 115b. The transmission points 115 are in turn connected over connection lines 116 to a shared baseband-processing unit 110 in the cellular network. In the illustrative example of FIG. 9, the cellular modem/router UE0 is configured for uplink transmission in two layers, whereas the laptop computer UE1 is configured for uplink transmission in only one single layer. Configuring the cellular modem/router UE0 and the laptop computer UE1 to operate as a RVUE 300 results in improved coverage for these devices.

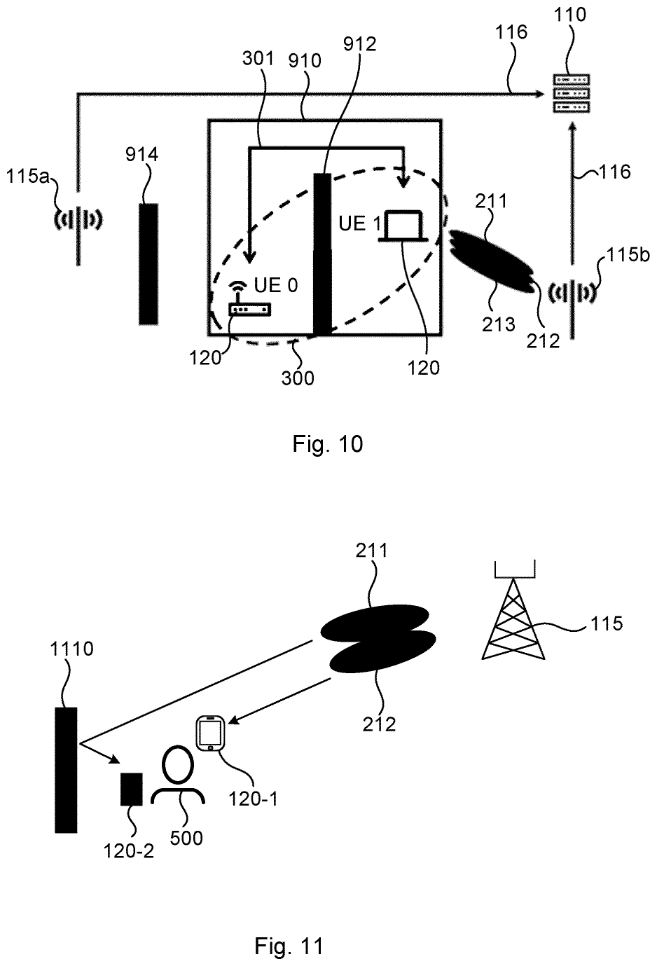

To further illustrate this advantage, the situation in FIG. 10 may be considered, where the radio connection between UE0 and its serving TRP is rendered inoperable by a further blocking wall 914. If UE1 is capable of uplink transmission using three layers, then UE0 can reroute its uplink traffic to UE1 to retain a connection to the cellular network, where the uplink transmission from UE1 in one of the three layers is done on behalf of UE0.

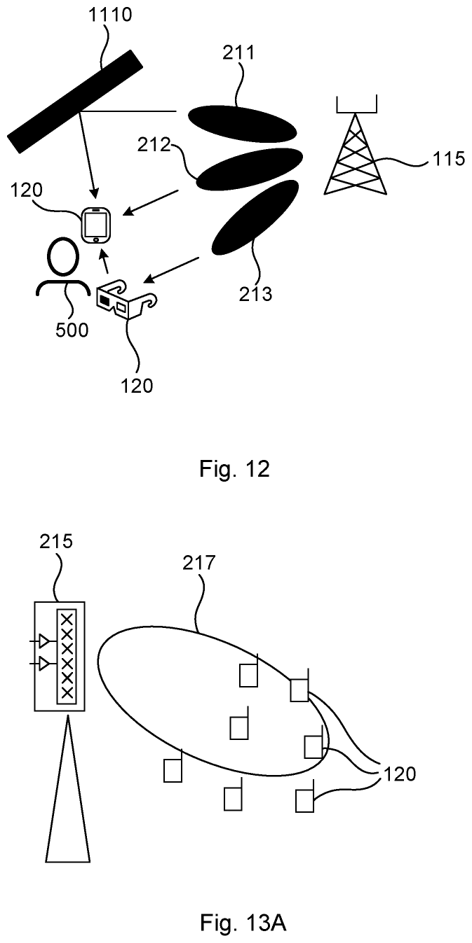

FIG. 12 illustrates that a dual-port wireless device 120, such as an advanced mobile phone, may contemporaneously prefer one beam 212 which corresponds to a line-of-sight to a transmission point 115 and one beam 211 which reaches the transmission point 115 after at least one reflection on a reflective surface 1110.

It is envisaged that one wireless device 120 may be allowed to operate as part of one or multiple RVUEs 300 at the same time, or as part of no RVUE at all.

The inventors have realized that a straightforward solution to beam management for RVUEs would be to configure each device 120 of the RVUE 300 with a separate beam report, such that each device reports its own preferred gNB beam(s) 211 to the network 110. However, having many devices report their own preferred gNB beam(s) 211, and corresponding performance measures, would typically be a waste of signaling since it is expected that in the majority of cases most or all of the devices belonging to a RVUE 300 will have the same best gNB beam(s) 211. Indeed, the devices 120 are normally located in close proximity of each other.

Another option that the inventors have considered is to configure the RVUE 300 with a single beam report, where the RVUE 300 reports the best gNB beam(s) 211 for the group of wireless devices 120 belonging to the RVUE 300. This will save overhead in the short perspective. In some cases, however, one device might be blocked by the user's 500 body or a physical object and hence needs another gNB beam with a different propagation path. This is schematically illustrated in FIG. 11, where the left device 120-2 is blocked by the user's 500 body and thus prefers the upper gNB beam 211, which reaches the transmission point 115 via a reflecting object 1110. The upper gNB beam 211 is different from the lower gNB beam 212, which corresponds to a direct line of sight from the transmission point 115 to the right device 120-1, and which is therefore preferred by the right device 120-1.

By the following methods, it appears possible to reconcile the seemingly conflicting goals of maintaining a low signaling overhead and communicating on well-adapted beams with good performance.

As illustrated in flowchart form in FIG. 14, there is proposed a method 1400 in a UE 120. It is recalled that a UE is a device which is, according to the network protocols in place, expected to interact with the network 110, at specific times or when different technical conditions are fulfilled. In particular, a UE may be expected to perform beam management, by means of beam measurements, beam reporting and by executing beam control information. A UE may thus be configured to operate as a coordinator UE or non-coordinator UE in a RVUE, whereas a wireless device that is not a UE may be configured as an additional transceiver device in a RVUE.

In a first step 1402 of the method 1400, a configuration is received from the network 110. The configuration mandates the UE 120 to operate as coordinator UE in a RVUE 300. The RVUE 300 may be newly formed or existing. In view of the intended benefits of the RVUE-coordinated beam management, it is understood (this might not be explicit from the configuration), that the RVUE 300 includes at least one non-coordinator UE.

In a second step 1404, the (coordinator) UE 120 indicates to the network 110, e.g. by higher-layer signaling, a capability of RVUE-coordinated beam management. The UE 120 may transfer this indication together with an indication that it belongs to a collection of wireless devices 120 with an intra-RVUE communication capability, as discussed above, with an optional indication of their spatial separation.

In a third step 1406, the (coordinator) UE 110 receives from the network a configuration of a RVUE-coordinated beam management procedure, in which a beam-reporting task is delegated from the non-coordinator UEs to the coordinator UE. It is noted that the first and third steps 1402, 1406 can be performed jointly, that is, the UE 120 receives a single message from the network 110 which mandates it to operate as part of an RVUE 300, as the coordinator UE therein, and to perform a RVUE-coordinated beam management procedure.

In a fourth step 1408, the (coordinator) UE 120 performs measurements and reporting in accordance with the configuration of the RVUE-coordinated beam management procedure, as detailed below.

In optional later steps of the method 1400, the RVUE-coordinated beam management procedure may include a transmission from the network 110 to the coordinator UE 120 of a beam control message. If the beam control message contains beam control information addressed to a non-coordinator UE in the RVUE, the coordinator UE forwards said beam control information to the non-coordinator UE.

FIG. 15 is a flowchart of a method 1500 related to the one just described, namely, to be performed by a UE 120 which is to operate as a non-coordinator UE in a RVUE 300.

The method 1500 begins with a first step 1502 of receiving a configuration from a network 110 for the UE to operate as non-coordinator UE in a RVUE 300, which further includes one coordinator UE and optionally at least one further non-coordinator UE.

In a second step 1504, the non-coordinator UE receives from the coordinator UE an indication that a RVUE-coordinated beam management procedure shall be performed, in which a beam-reporting task is delegated from the non-coordinator UEs to the coordinator UE.

In a third step 1506, the non-coordinator UE 120 performs measurements in accordance with the RVUE-coordinated beam management procedure.

In a fourth step 1508, the non-coordinator UE 120 transmits beam-related information to the coordinator UE. The beam-related information may include data captured during the measurements in step 1506, or one or more preferred base-station beams selected on the basis of the measurements. As mentioned above, the preferred base-station beam or beams may be identified using a DL-RS index. The coordinator UE may be expected to forward the beam-related information to the network 110, or to process it together with further beam-related information from itself or from other devices in the RVUE.

In particular, the beam-related information indicates at least one base-station beam preferred by the non-coordinator UE, which is to be reported to the network, and optionally a beam performance indicator for each of one or more base-station beams. Further, the beam-related information may include a beam performance indicator determined based on measurements by the non-coordinator UE. Beam-related information with such a beam performance indicator determined based on the non-coordinator UE's measurements may include one or more of:
reference signal received power, RSRP, measured by the non-coordinator UE on a base-station beam (RSRP_{DL});
uplink RSRP corresponding to the RSRP measured by the non-coordinator UE on the base-station beam plus an available output power of the non-coordinator UE (RSRP_{UL}=RSRP_{DL}+Pₒᵤₜ);
a signal to interference and noise ratio, SINR, measured by the non-coordinator UE on a base station beam;
the non-coordinator UE's number of receive chains;
the non-coordinator UE's number of transmit chains;
an estimate of total downlink user throughput on a base-station beam for the non-coordinator UE;
an estimate of total uplink user throughput on a base-station beam for the non-coordinator UE;
an estimate of a maximally supported downlink transmission rank on a base-station beam for the non-coordinator UE;
an estimate of a maximally supported uplink transmission rank on a base-station beam for the non-coordinator UE.

In some embodiments, the beam-related information may relate to a relatively wider beam, wherein the non-coordinator UE is further configured to perform measurements on a set of relatively narrower base-station beams and to report a preferred beam or beams from this set to the network.

FIG. 16 is a flowchart of acts performed in the network node 110 during an execution of the methods 1400, 1500 shown in FIGS. 14 and 15. From the network node's 110 perspective, more precisely, the RVUE-coordinated beam management is realized as follows.

In a first step 1602, the network node 110 configures a UE 120 to operate as coordinator UE in a RVUE 300, and it configures one or more further UEs 120 to operate as non-coordinator UEs in the same RVUE 300.

In a second step, 1604, the network node 110 receives from the coordinator UE an indication of a capability of RVUE-coordinated beam management. As noted above, the indication may be accompanied by—or may have been preceded by—a further indication that the coordinator UE belongs to a collection of wireless devices 120 capable of operating as a RVUE (i.e., they have an intra-RVUE communication capability) and optionally an indication of the spatial separation of these wireless devices.

In a third step 1606, the network node 110 transmits to the coordinator UE a configuration of a RVUE-coordinated beam management procedure, in which a beam-reporting task is delegated from the non-coordinator UEs to the coordinator UE.

Next, in a fourth step 1608, the network node 110 receives reporting (beam reporting) from the coordinator UE in accordance with the configuration of the RVUE-coordinated beam management procedure.

Specific embodiments of these methods 1400, 1500, 1600 will now be described.

### First Group of Embodiments

In a first group of embodiments, as shown in FIG. 3, a beam report 310 is divided into two different parts, where the first part 311 (mandatory report part) contains a main N best beams and corresponding performance measures for the RVUE. The best beams may be identified by listing the beams in descending order of RSRP or in descending order of SINR, and extracting the top N beams. The first part 311 may have the same format as the beam reports currently specified in 3GPP NR. An additional field may be included in the first part 311 beam report (e.g., at the beginning or end), which is used to indicate whether a second part 312 (optional report part) of the beam report will be reported by the UE or not. The second part of the beam report is only reported in case one or more devices of the RVUE 300 has other preferred gNB beam(s). The new field at the end of the first part 311 of the beam report can for example indicate the number of devices that have different optimal gNB beams, such that the gNB will know the size of the second part 312 of the beam report 310; this may be needed for the gNB to properly decode the beam report.

A simplified example of the appearance of the beam report 310 is presented in Tables 1 and 2.

TABLE 1
Fields in Mandatory report part

Beam index#1
Beam index#2, if reported
Beam index#3, if reported
Beam index#4, if reported
Performance measure for beam index#1
Performance measure for beam index#2, if reported
Performance measure for beam index#3, if reported
Performance measure for beam index#4, if reported
Number of devices with other preferred beams in Optional report part

TABLE 2
Fields in Optional report part

Device index for Device 1, if reported
Beam index#1 for Device 1, if reported
Beam index#2 for Device 1, if reported
Beam index#3 for Device 1, if reported
Beam index#4 for Device 1, if reported
Performance measure for beam index#1 for Device 1, if reported
Performance measure for beam index#2 for Device 1, if reported
Performance measure for beam index#3 for Device 1, if reported
Performance measure for beam index#4 for Device 1, if reported
.
.
.
Device index for Device M, if reported
Beam index#1 for Device M, if reported
Beam index#2 for Device M, if reported
Beam index#3 for Device M, if reported
Beam index#4 for Device M, if reported
Performance measure for beam index#1 for Device M, if reported
Performance measure for beam index#2 for Device M, if reported
Performance measure for beam index#3 for Device M, if reported
Performance measure for beam index#4 for Device M, if reported

Here, the beam indices may be indices to DL RS resources. It is noted that the Optional report part relates to M devices in this example. Each device is identified by a device index, which can be a globally unique UE identifier or a temporary network identity, such as TMSI. For the purposes of the beam management, however, it may be much simpler (and thus shorter), such as a sequence number which is used consistently in each session between the coordinator UE 120 and the network 110, which is normally sufficient to allow the network 110 to allocate a beam to a UE on the basis of the same UE's beam reporting. For this purpose, the coordinator UE 120 and/or the network node 110 can maintain a mapping table.

With this format, the RVUE can be configured to report in part 1 of the beam report (Mandatory report part) up to N=4 best gNB beams and corresponding performance measures, as well as indicating how many other devices that have separate preferred gNB beams, which then would be included in part 2 of the beam report. Note that since in most cases the same gNB beam will be optimal for all devices in the RVUE 300, the part 2 of the beam report will typically not be needed, which will reduce the signaling overhead spent on beam reports compared to having one beam report per device. When different devices do have different preferred gNB beams, then the new proposed beam report could indicate this too, which offers a good flexibility compared to only having one beam report for the entire RVUE 300. The extra bitfield “Number of devices with other preferred beams in Optional report part” included in the first part of the beam report could be made very small, e.g., 2 bits might be enough to indicate the number of devices that have a separate preferred gNB beam, which is very small compared to a full beam report which typically consists of several tens of bits.

In part 2 of the beam report (Optional report part), the N best beams for each of the devices that has a different preferred beam compared to the rest of the RVUE is indicated, as well as a corresponding performance measure.

In one embodiment, a Device index is included in the second part of the beam report to indicate which device or devices have a different preferred gNB beam (as schematically illustrated in Table 2). This could be useful, for example, since different devices might have different number of TX and RX chains, different maximum output power (or other different capabilities that could have been indicated during UE capability signaling), which could help the gNB when scheduling the device with further signals and/or data. For example, if the UE reports that a device with a single RX/TX chain has another preferred gNB beam, then the gNB has the option of adapting the scheduled reference signal transmission (CSI-RS and/or SRS) and/or transmission rank of scheduled PDSCH/PUSCH when performing transmission or reception with the indicated device (when using the reported preferred gNB beam for that device).

In a further development, the Optional report part further includes, for the devices that have a different preferred beam, a performance measure relating to the best beam(s) reported in the Mandatory report part. When the network 110 receives an Optional report part with this content, the network 110 gets an approximate indication of how well the RVUE will perform if the devices appearing in the Optional report part (i.e., those preferring a different beam compared to the rest of the RVUE) are not allocated said different beam.

To summarize, in the first group of embodiments, a beam report 310 with a mandatory report part 311 and an optional report part 312 is sent to the network, wherein the mandatory report part indicates at least one base-station beam 211, 212, . . . , 217 preferred by the coordinator UE, and the optional report part indicates one or multiple base-station beams preferred by a non-coordinator UE in the RVUE. If a transmitted beam report includes the optional report part 312, then the mandatory report part 311 could indicate, implicitly or explicitly, the presence of the optional report part. Further, then the mandatory report part could indicate a number of and/or identifiers of those non-coordinator UEs to which the optional report part applies when the optional report part is present.

Whether the optional report part 312 shall be included or not can be determined (e.g., by the coordinator UE) by evaluating a pre-agreed or pre-specified criterion common to all devices served by the network. This way, because a uniform objective criterion is applied to all devices, the beam-management overhead can be efficiently controlled on system level. For example, the determination may be whether the respective base-station beams preferred by the coordinator UE and a non-coordinator UE coincide or approximately coincide (cf. beams 511 and 513 in FIG. 8). Alternatively or additionally, inclusion of the optional report part 312 can be triggered based on a difference between a beam performance indicator determined based on measurements by the coordinator UE and the same beam performance indicator determined based on measurements by a non-coordinator UE; if the difference is found to exceed a predefined threshold, the optional report part 312 is included.

### Second Group of Embodiments

The second group of embodiments is suitable for use cases with a relatively tight overhead budget. The inventors have realized that, even though a drastic reduction of the overhead for beam management procedures could be achieved by only reporting a single beam, which is preferred by one of the devices 120 in the RVUE 300, and use this for all the devices 120. This beam selection may however be misleading, since the best beam for one of the devices of the RVUE 300 might not be the globally best gNB, when considering the full number of devices in the RVUE 300.

It is therefore proposed, according to the present group of embodiments, to use a novel beam report by which the RVUE 300 can report a gNB beam (collectively preferred base-station beam) that is preferred with respect to all the devices 120 belonging to the RVUE 300. For example, when configured with the novel beam report, the specifications require the RVUE 300 to use data from all the devices 120 of the RVUE 300 when estimating the performance of the candidate gNB beams. The estimation may utilize some performance metric calculated over all the devices of the RVUE (joint performance metric). The coordinator UE 120 shall report back a preferred gNB beam to the network 110 that has been selected based on the performance metric. In this case, some metric other than RSRP and SINR might be included in the beam report. For example, the beam report may indicate the total number of RX and/or TX chains (summed over all the devices of the RVUE) that can use the preferred gNB beam with adequate performance. From this information, the gNB is able to estimate the maximum total number of DL layers (DL rank) and/or UL layers that can be used for the reported preferred gNB beam. An alternative performance measure could be DL and or UL user throughput.

To summarize, when the RVUE-coordinated beam management procedure is performed according to the second group of embodiments, the coordinator UE selects at least one collectively preferred base-station beam based on a joint performance metric evaluated for coordinator and non-coordinator UEs in the RVUE, and to transmit a beam report indicating said collectively preferred base-station beam. It may be implicit from the type of beam report that the indicated base-station beam is collectively preferred rather than individually preferred.

In different embodiments, the joint performance metric includes one or more of:
reference signal received power, RSRP, value averaged over said coordinator and non-coordinator UEs in the RVUE. In other words, the coordinator UE and each of the non-coordinator UEs in the RVUE measure a respective RSRP value (RSRP_{DL,i}) on a base-station beam, and these RSRP values are averaged

$$( \frac{1}{N} {\sum }_{i = 1}^{N} R S R {P}_{DL , i} ) ;$$

uplink RSRP value, corresponding to RSRP measured on a base-station beam plus an available output power of the respective receiving UE, averaged over the coordinator UE and non-coordinator UEs

$$( \frac{1}{N} {\sum }_{i = 1}^{N} ( R S R {P}_{DL , i} + {P}_{out , i} ) ) ;$$

a signal to interference and noise ratio, SINR, averaged over said coordinator and non-coordinator UEs in the RVUE for a base-station beam;
a total number of receive chains in the coordinator UE, the non-coordinator UEs and any additional transceiver devices in the RVUE;
a total number of transmit chains in the coordinator UE, the non-coordinator UEs and any additional transceiver devices in the RVUE;
an estimate of total downlink user throughput on a base-station beam for the coordinator UE, the non-coordinator UEs and any additional transceiver devices in the RVUE;
an estimate of total uplink user throughput on a base-station beam for the coordinator UE, the non-coordinator UEs and any additional transceiver devices in the RVUE;
an estimate of a maximally supported downlink transmission rank on a base-station beam;
an estimate of a maximally supported uplink transmission rank on a base-station beam.
   To evaluate these and other joint performance metrics, the coordinator UE may receive beam-related information from the non-coordinator UEs. For example, it may receive a RSRP value measured by the non-coordinator UE on a base-station beam which is one of the candidates for the collectively preferred base station beam.

Further, in different embodiments, the beam report could include one or more of the following performance measures, which may or may not coincide with the criterion that was used for selecting the collectively preferred base-station beam:
a total number of receive chains in the coordinator UE, the non-coordinator UEs and any additional transceiver devices in the RVUE associated with each of the collectively preferred base-station beam or beams;
a total number of transmit chains in the coordinator UE, the non-coordinator UEs and any additional transceiver devices in the RVUE;
an estimate of total downlink user throughput on said at least one collectively preferred base-station beam for the coordinator UE, the non-coordinator UEs and any additional transceiver devices in the RVUE;
an estimate of total uplink user throughput said at least one collectively preferred base-station beam for the coordinator UE, the non-coordinator UEs and any additional transceiver devices in the RVUE;
an estimate of a maximally supported downlink transmission rank on said at least one collectively preferred base-station beam;
an estimate of a maximally supported uplink transmission rank on said at least one collectively preferred base-station beam.

It is noted finally that the joint performance metric may be evaluated for one or more additional transceiver devices in the RVUE 300 if such are included.

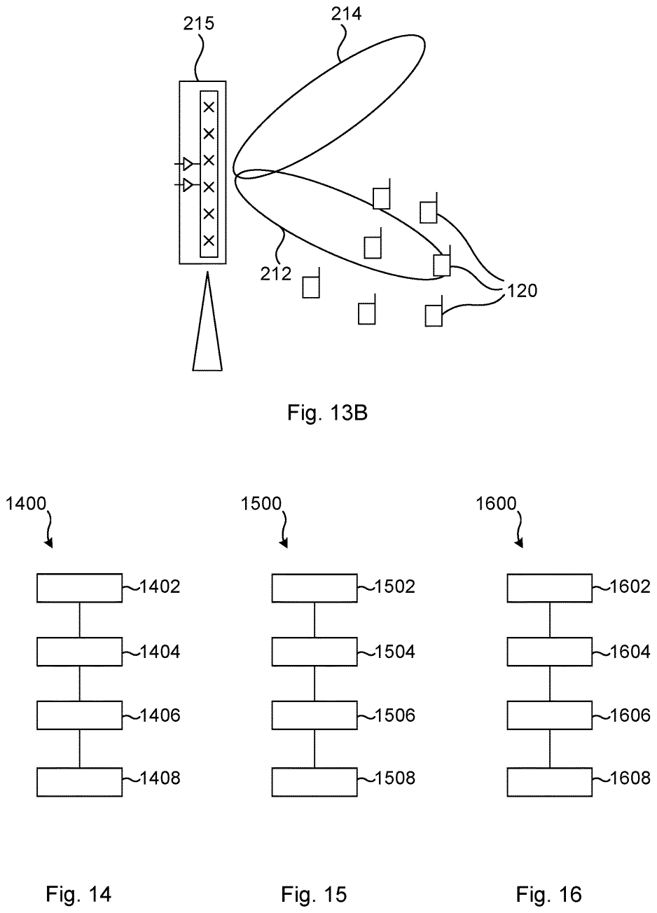

FIG. 13 illustrates an example situation where a RVUE's 300 collectively preferred base-station beam 217 is relatively wider (FIG. 13A) and where the devices 120 within the RVUE 300 have the option of selecting relatively narrower preferred base-station beams 211, 212 (FIG. 13B). This may be supported by embodiments within the second group.

### Third Group of Embodiments

In the third group of embodiments, the legacy beam management procedures, as described in the Background section, are assumed to be used for a RVUE. Notably, the procedures P-1 and P-2 may be used. In current millimeter-wave product implementations, a P-1 beam report (i.e., a UE reporting N best SSB beams and corresponding performance measures) and a P-2 beam report (i.e., a UE reporting N best narrow beams and corresponding performance measures) are typically triggered rather frequently and individually per UE. This is to say, each UE reports its own preferred SSB beam and narrow beams. The narrow beams used for a P-2 beam sweep are typically the narrow beams located within or in close vicinity of the strongest reported SSB beam.

The inventors have realized that configuring each device of a RVUE with frequent beam reports for both SSB beams (P-1 procedure) and narrow beams (P-2 procedure) would require significant beam report overhead signaling. Since it is expected that most of the devices of a RVUE are located in close proximity of each other, it is expected that the respective best gNB beams the multiple devices in the RVUE will be oriented in directions close to each other. Hence, it is likely that the different devices are all covered by the same wide SSB beam. The narrow beams may be particularly useful in conditions where the user's body or physical objects block one or more devices in the RVUE, wherein different narrow beams, pointing in slightly different directions, might be optimal for the different devices of the RVUE.

According to the present group of embodiments, in order to balance the overhead against flexibility, a single SSB beam report is configured for the RVUE as a whole (e.g., to be transmitted by one of the devices in the RVUE), and separate P-2 beam reports are configured for the respective devices therein, so that a dedicated narrow gNB beam can determined for each device. A benefit to be expected with this solution is that the beam management overhead can be reduced, indeed, since only one SSB beam report is signaled for all the devices of the RVUE, while we still have the flexibility to determine a narrow beam per device. The narrow beam is expected to lie within the best reported SSB beam.

In an advantageous combination of embodiments from the third and second groups, a SSB beam report using a joint performance metric over all the devices in a RVUE (see the preceding section), is used to select the wide SSB beam for the RVUE, and then dedicated P-2 beam sweeps are triggered per device of the RVUE to determine a preferred narrow beam per device.

To summarize, the collectively preferred base-station beam is a relatively wider beam (e.g., SSB beam, periodic CSI-RS) in this third group of embodiments, and the RVUE-coordinated beam management procedure further includes the coordinator and non-coordinator UEs 120 in the RVUE 300 reporting to the network 110 their respective preferred base-station beams selected from a set of relatively narrower beams (e.g., aperiodic or semi-persistent CSI-RS). The network 110 may support this RVUE-coordinated beam management procedure by sweeping a set of relatively narrower base-station beams after it has received a beam report indicating at least one collectively preferred base-station beam. It may then expect the coordinator UE to send further beam reporting indicating the coordinator UE's and/or non-coordinator UEs' respective preferred base-station beams.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1-35. (canceled)

36. A first user equipment (UE) configured to operate as coordinator UE for a reconfigurable virtual user equipment (RVUE) comprising the first UE and a non-coordinator UE, the first UE comprising:
a radio interface; and
processing circuitry, wherein the first UE is configured to perform a method comprising:
indicating to a network node a capability of RVUE-coordinated beam management;
receiving a configuration of a RVUE-coordinated beam management procedure, in which a beam-reporting task is delegated from the non-coordinator UE to the first UE; and
perform measurements and reporting in accordance with the configuration of the RVUE-coordinated beam management procedure.

37. The first UE of claim 36, wherein
the method further comprises transmitting, within the RVUE-coordinated beam management procedure, a beam report with a mandatory report part and an optional report part, and
the mandatory report part indicates at least one base-station beam preferred by the first UE, and the optional report part indicates at least one base-station beam preferred by a non-coordinator UE in the RVUE.

38. The first UE of claim 37, wherein
the method further comprises determining, within the RVUE-coordinated beam management procedure, whether the optional report part shall be included in the beam report on the basis of at least one of the following criteria:
whether the respective base-station beams preferred by the first UE and the non-coordinator UE coincide; and
whether a difference between a beam performance indicator determined based on measurements by the first UE and the beam performance indicator determined based on measurements by the non-coordinator UE exceeds a predefined threshold.

39. The first UE of claim 36, wherein
the method further comprises selecting, within the RVUE-coordinated beam management procedure, at least one collectively preferred base-station beam based on a joint performance metric evaluated for the RVUE, and
the method further comprises transmitting a beam report indicating the collectively preferred base-station beam.

40. The first UE of claim 39, wherein the joint performance metric is further evaluated for one or more additional transceiver devices in the RVUE.

41. The first UE of claim 39, wherein the joint performance metric comprises:
a reference signal received power (RSRP) value averaged over the first UE and one or more non-coordinator UEs in the RVUE;
an uplink RSRP value, corresponding to RSRP measured on a base-station beam plus an available output power of the respective receiving UE, averaged over the first UE and the non-coordinator UEs in the RVUE;
a signal to interference and noise ratio (SINR) averaged over the first UE and non-coordinator UEs in the RVUE for a base-station beam;
a total number of receive chains in the first UE, the non-coordinator UEs and any additional transceiver devices in the RVUE;
a total number of transmit chains in the first UE, the non-coordinator UEs and any additional transceiver devices in the RVUE;
an estimate of total downlink user throughput on a base-station beam for the first UE, the non-coordinator UEs and any additional transceiver devices in the RVUE;
an estimate of total uplink user throughput on a base-station beam for the first UE, the non-coordinator UEs and any additional transceiver devices in the RVUE;
an estimate of a maximally supported downlink transmission rank on a base-station beam; and/or
an estimate of a maximally supported uplink transmission rank on a base-station beam.

42. The first UE of any of claim 39, wherein
the method further comprises transmitting, within the RVUE-coordinated beam management procedure, a beam report indicating:
a total number of receive chains in the first UE, the non-coordinator UE, and any additional transceiver devices in the RVUE associated with each of the collectively preferred base-station beam or beams;
a total number of transmit chains in the first UE, the non-coordinator UE, and any additional transceiver devices in the RVUE associated with each of the collectively preferred base-station beam or beams;
an estimate of total downlink user throughput on the at least one collectively preferred base-station beam for the first UE, the non-coordinator UE, and any additional transceiver devices in the RVUE;
an estimate of total uplink user throughput the at least one collectively preferred base-station beam for the first UE, the non-coordinator UE, and any additional transceiver devices in the RVUE;
an estimate of a maximally supported downlink transmission rank on the at least one collectively preferred base-station beam; and/or
an estimate of a maximally supported uplink transmission rank on the at least one collectively preferred base-station beam.

43. The first UE of claim 39, wherein:
the collectively preferred base-station beam is a relatively wider beam; and
the RVUE-coordinated beam management procedure further includes the coordinator and non-coordinator UEs in the RVUE reporting to the network their respective preferred base-station beams selected from a set of relatively narrower beams.

44. A method in a first user equipment (UE), the method comprising:
receiving a configuration for the first UE to operate as coordinator UE in a reconfigurable virtual user equipment (RVUE), the RVUE comprising the first UE and a non-coordinator UE;
indicating to a network node a capability of RVUE-coordinated beam management;
receiving a configuration of a RVUE-coordinated beam management procedure, in which a beam-reporting task is delegated from the non-coordinator UE to the first UE; and
performing measurements and reporting in accordance with the configuration of the RVUE-coordinated beam management procedure.

45. A first user equipment (UE) configured to operate as non-coordinator UE in a reconfigurable virtual user equipment (RVUE), the RVUE comprising the first UE and a coordinator UE, the first UE comprising:
a radio interface; and
processing circuitry, wherein the first UE is configured to perform a method comprising:
receiving from the coordinator UE an indication that a RVUE-coordinated beam management procedure shall be performed, in which a beam-reporting task is delegated from the first UE to the coordinator UE;
perform measurements in accordance with the RVUE-coordinated beam management procedure; and
transmit beam-related information to the coordinator UE.

46. A method in a first user equipment (UE), the method comprising:
receiving a configuration for the first UE to operate as non-coordinator UE in a reconfigurable virtual user equipment (RVUE), the RVUE comprising the first UE and coordinator UE;
receiving from the coordinator UE an indication that a RVUE-coordinated beam management procedure shall be performed, in which a beam-reporting task is delegated from the first UE to the coordinator UE;
performing measurements in accordance with the RVUE-coordinated beam management procedure; and
transmitting beam-related information to the coordinator UE.
